(19) United States
(12) Patent Application Publication
(10) Pub. No.: US 2011/0231211 A1
(43) Pub. Date: Sep. 22, 2011

(54) METHODS AND APPARATUS FOR ISSUING A GIFT ANNUITY

(75) Inventor: James P. Griffin, Cazenovia, NY (US)

(73) Assignee: MONEYINS, INC., Cazenovia, NY (US)

(21) Appl. No.: 13/149,574

(22) Filed: May 31, 2011

Related U.S. Application Data
(63) Continuation-in-part of application No. 12/771,885, filed on Apr. 30, 2010.
(60) Provisional application No. 61/174,797, filed on May 1, 2009.

(51) Int. Cl. G06Q 40/00

(52) U.S. Cl. 705/4

(57) ABSTRACT

The teachings disclosed herein can be directed to an intermediary coordinating the administration of a 54Freedom gift annuity arrangement between a donor and both a charity and insurance company. The charity receives the gift and the annuity contract is between the donor and the insurance company. This arrangement provides flexibility in the annuity contract, a new financial product for financial specialists to market, a more certain financial annuity arrangement post-mortem for the donor's estate, and a better incentivized financial party to which the donor can consult. The method can include consultation by the intermediary, e.g. a financial specialist, with the donor to determine a suitability of an annuity contract for the donor. The method can further include coordination by the intermediary of a purchase of the annuity contract by the donor with an insurance company as opposed to with the charity, which receives the gift.

### CROSS-REFERENCE TO RELATED APPLICATIONS

This application is a continuation-in-part of U.S. Patent Application Ser. No. 12/771,885 filed Apr. 20, 2010, which claims the benefit of U.S. Provisional Patent Application Ser. No. 61/174,797 filed May 1, 2009; the contents of both patent applications are hereby incorporated herein by reference.

### BACKGROUND OF THE INVENTION

1. The Field of the Invention

The present invention relates to 54Freedom^{SM}gift annuity arrangements and contracts between donor/annuitant, insurance companies, and charities.

2. The Relevant Technology

An annuity is a well-known financial product used to pay a person a certain sum of money in a series of distributions made at regular intervals, such as monthly or annually. The payments are based on a given amount of principal consisting of an initial contribution of assets and any subsequent contributions and the appreciation (or depreciation) of the contributions. Annuities are characterized by an accumulation phase and a payout phase. During the accumulation phase, the annuity owner makes one or more purchase payments toward the value of the annuity account, and the annuity account value fluctuates, hopefully upwardly, based on the performance of one or more investment alternatives to which the account value is allocated. During the payout phase, the account value is applied to an income plan of the annuity owner's choosing under which the owner, or the owner's designee, will receive a specified number of income payments or income payments for a specified period.

According to the American Council on Gift Annuities (ACGA), a traditional charitable gift annuity is a contract (not a “trust”), under which a charity, in return for a transfer of cash, marketable securities or other assets, agrees to pay a fixed amount of money to one or two individuals, for their lifetime. Therefore, traditionally, the contract is directly between the charity and a donor.

A person who receives payments is called an “annuitant” or “beneficiary”. The payments are fixed and unchanged for the term of the contract. A portion of the payments are considered to be a partial tax-free return of the donor's gift, which are spread in equal payments over the life expectancy of the annuitant(s).

A charitable gift annuity is a gift vehicle that falls in the category of planned giving. It involves a contract between a donor and a charity, whereby the donor transfers cash or property to the charity in exchange for a partial tax deduction and a lifetime stream of annual income from the charity. Importantly, according to a traditional charity gift annuity, when the donor dies, the charity keeps the gift.

The amount of the income stream is determined by many factors including the donor's age and the policy of the charity. Most charities use payout rates defined by the American Council on Gift Annuities.

A “traditional” charitable gift annuity enables a donor to transfer cash, marketable securities or real estate to the charitable organization issuing the gift annuity in exchange for a current income tax deduction and the organization's promise to make fixed annual payments to the donor for life Annuity payments can begin immediately or can be deferred to some future date.

Usually, the annuitant is also the donor, but this is not always true. Traditionally, the maximum number of annuitants is two, and payments can be made to them jointly or successively. Payments from a traditional charitable gift annuity are fixed from the outset. They will neither increase nor decrease, whatever happens to interest rates or the stock market. A charity is contractually obligated to make the payments, even if it has to dip into its general funds to do so.

The contributed property (the gift), given irrevocably, becomes a part of the charity's assets, and the payments are a general obligation of the charity. The annuity is backed by the charity's entire assets, not just by the property contributed. Annuity payments continue for the life/lives of the annuitant(s) no matter what the investment experience of the gift annuity fund.

The ACGA suggested rates assume that the entire gift is invested and held in reserve until the termination of the contract, at the death of the sole or surviving annuitant. The remaining portion of the contribution at that time is called the “residuum”. The ACGA suggested rates also assume that the residuum will be at least 50% of the initial gift amount, if the annuitant(s) live only to their life expectancy, which is a requirement of many of the state gift annuity laws.

The charity should establish a means to track the ongoing value of each gift within its gift annuity fund, so that it can withdraw the correct residuum amount (based on the “market value”, not “book value” of each gift's residuum balance).

With an immediate gift annuity, the annuitant(s) start(s) receiving payments at the end (or the beginning) of the payment period immediately following the contribution. Payments can be made monthly, quarterly, semi-annually or annually. The most common arrangement is quarterly payments at the end of the quarter. The end of a period is not the first day of a month, but the last day of a month or period, or the anniversary date of the gift. The first payment is customarily prorated from the date of the contribution to the end of the first period, and thus is smaller than the subsequent payments, but it is possible to stipulate that the first payment be for the full amount. All of these factors have some effect on the amount of the charitable deduction.

The annual annuity is determined by multiplying the amount contributed (measured as the fair market value on the gift date, not the net proceeds of sale if a charitable gift annuity is funded with securities) by the annuity rate.

With a Deferred Payment Gift Annuity (DPGA), the annuitant(s) start(s) receiving payments at a future time, the date chosen by the donor, which must be more than one year after the date of the contribution. As with immediate gift annuities, payments can be made monthly, quarterly, semi-annually or annually.

A Flexible (Deferred Payment) Gift Annuity means that the donor does not have to choose the payment starting date at the time of the contribution. The annuitant (who may or may not be the donor) may choose the payment starting date based on his/her retirement date or other considerations. The older the annuitant(s) when the payments start, the larger the payments will be.

If the gift annuity is funded with cash, part of the payments will be taxed as ordinary income and part will be tax-free. If funded with appreciated securities or real estate owned more than one year, and the donor is receiving the annuity payments, part of the payments will be taxed as ordinary income, part as capital gain, and part may be tax-free. The charity that issues the annuity will send a Form 1099-R to the annuitant. This form will specify how the payments should be reported for income tax purposes.

Taxpayers who itemize deductions can claim a charitable deduction for a portion of the original gift. This deduction can result in significant income tax savings. In short, the deduction is equal to the amount of the contribution less the present value of the payments that will be made to the donor and/or other beneficiary during life. The present value of those payments is determined using IRS tables regarding life expectancy and assumed earnings, and taking into consideration the amount contributed and the gift annuity rate.

The subject matter claimed herein is not limited to embodiments that solve any disadvantages or that operate only in environments such as those described above. Rather, this background is only provided to illustrate one exemplary technology area where some embodiments described herein may be practiced

### BRIEF SUMMARY OF THE INVENTION—54FREEDOM GIFT ANNUITY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

The teachings disclosed herein can be generally, but not necessarily most narrowly, directed to a method performed by an intermediary for coordinating the administration of a 54Freedom Gift Annuity arrangement for a donor. The method can include consultation by the intermediary with the donor to determine a suitability of an annuity contract for the donor. The method can further include coordination by the intermediary of a purchase of the annuity contract by the donor with an insurance company. And, the method can further include coordination by the intermediary of a first charitable donation to a first charitable not-for-profit organization, wherein the annuity contract is guaranteed by the insurance company.

The teachings disclosed herein can be generally, but not necessarily most narrowly, directed to a method performed by an intermediary for coordinating the administration of a 54Freedom Gift Annuity arrangement for a donor/annuitant. The method can include application for an annuity by the intermediary on the behalf of a donor with an insurance company. The method can further include coordination by the intermediary of a first charitable donation to a first charitable not-for-profit organization, the first charitable donation being associated with the annuity. The annuity contract is guaranteed by the insurance company and part of the payments of the annuity are taxed as ordinary income and part of the payments of the annuity are tax-free due to the charitable donation.

The teachings disclosed herein can be generally, but not necessarily most narrowly, directed to a method performed by an intermediary for coordinating the administration of a 54Freedom gift annuity arrangement for a donor. The method can include consultation by the intermediary with a donor to determine a suitability of an annuity contract for the donor. This consultation can include solicitation of financial information from the donor including the donor's annual income, investment objectives, risk tolerance, and tax rate, consultation by the intermediary with the donor to determine a financial goal of the donor, consultation by the intermediary with the donor to determine a risk tolerance of the donor, and solicitation of the donor's age. The method can further include selection of the annuity contract based on the consultation by the intermediary with the donor including the suitability of the annuity contract with the donor's annual income, investment objectives, risk tolerance, tax rate, financial goal, and donor's age. The method can further include coordination by the intermediary of a purchase of the annuity contract by the donor with an insurance company. The method can further include coordination by the intermediary of a first charitable donation to a first charitable not-for-profit organization. The annuity contract is guaranteed by the insurance company instead of the charitable not-for-profit organization where neither the insurance company nor the charity employ the intermediary.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A and 1B illustrate a draft fillable certified public accountant's review letter;

FIG. 2 illustrates a 54Freedom Gift Annuity gift annuity preliminary inquiry questionnaire;

FIGS. 3A-3F illustrate an example of a 54Freedom Gift Annuity annuity suitability questionnaire;

FIGS. 4A and 4B illustrate a 54Freedom Gift Annuity gift proposal;

FIGS. 5A-5C illustrate hypothetical examples of methods performed by an intermediary for coordinating the administration of a 54Freedom Gift Annuity arrangement;

FIG. 6 illustrates a method performed by an intermediary for coordinating the administration of a 54Freedomgift annuity arrangement for a donor; and

FIG. 7 is an example of a letter sent by the intermediary to the charity enclosing a check for the charitable donation to coordinate payment of the charitable donation.

### DETAILED DESCRIPTION OF THE PREFERRED EMBODIMENTS

Potential charitable donors who are generally fifty or older and have often spent a lifetime working hard and saving money. Such charitable donors often own assets that have appreciated a great deal over the years. As a result, these donors are often facing a large capital gains tax, should they access this capital. The assets may be in a large certificate of deposit (CD), an individual retirement account (IRA), a tax-deferred annuity, or some other financial instrument. If these assets remain in their estate, their heirs may face estate tax consequences.

Such potential donors may want to use this capital to create a fixed stream of income payable to themselves for the rest of their life. Or, they may want to direct a stream of income to their spouse, to one or more children or grandchildren, to a disabled family member, or to some other loved one. Also, they might welcome the opportunity to make a significant donation to a charity, school, religious organization, or cause-related group or foundation that is important to them.

A traditional gift annuity allows such a donor to make a gift to a charity, and still receive an income for themselves or others. As part of the traditional transaction, the charity, in return for a transfer of cash or other accumulated assets, agrees to pay a fixed sum of money over one or two lives. The payments from the charitable gift annuity are fixed and will not fluctuate.

However, a traditional charitable gift annuity is substantially inflexible, impersonally designed, and inconvenient in many ways. For example, a traditional charitable gift annuity makes a donation to a single charity only. In the event of the death of the donor all remaining funds are retained by the charity. The annuity promise is kept by the charity and the annuity obligation sits on the charity's balance sheet. And, a traditional charitable gift annuity is limited to a single premium immediate annuity.

According to the embodiments of the invention disclosed herein, with the 54Freedom Gift Annuity, the donor has the flexibility to direct donation to multiple charities and not-for-profit organizations. The 54Freedom Gift Annuity product is made up of a donation and an annuity; and not a combined Charitable Gift Annuity, whereas the Donor makes a donation to a 54Freedom Affiliated Charity, and the donor also buys an annuity from an insurance company. The donor is provided certainty of a 5, 10, or 15 year payout (depending on age), and/or other form of annuity such as an investment annuity to the donor (or their estate). The annuity promise is kept by a national insurance carrier (e.g. Lincoln Life). There is a commissionable insurance product involved that provides compensation for an intermediate party, such as a financial instrument marketing company, that coordinates the transaction. And, the process affords for customization to include other forms of annuity products (e.g. deferred annuity as well as long term care coverage, joint and survivor life insurance, etc.).

The methods disclosed herein also provide donor benefits in tax planning and estate planning services, annual payments to donors and/or designees and may reduce estate taxes. Financial professionals also benefit from this arrangement where the methods may address a critical need for older clients, creates additional estate planning opportunity, provides excellent planning alternative in a declining market, provides clients at small and medium sized charities an additional way to raise funds and provides compensation. Therefore, according to the teachings disclosed herein there a new point of financial service created by the financial product according to the applicant's inventive methods and apparatus that can be marketed not only to the donor, but also to charities and insurance companies that would not otherwise be involved in such financial arrangements.

According to the embodiments disclosed herein, the 54Freedom Gift Annuity is arranged as an insurance carrier administered annuity product rather than by a traditional large “closed end” charity or “not for profit” administered annuity. Embodiments of the invention also relate to the issuance of a 54Freedom Gift Annuities including insurance carrier administered annuities coordinated by an intermediary, such as an independent financial specialist often employed by a financial product marketing company, who are paid to tailor the transaction in the best financial and life-planning interests of the donor. The intermediary is not employed by the charitable not-for-profit recipient of the charitable gift nor the financial institution issuing the annuity. Rather, although not required, advantageously the intermediary serves as an independent financial advisor acting in the best financial and life-planning interests of the donor.

As used herein, a charity, or charitable organization, includes a Section 501(c)(3) not-for-profit organization that qualifies as such organization under the federal tax code. To be tax-exempt under section 501(c)(3) of the Internal Revenue Code, an organization must be organized and operated exclusively for exempt purposes set forth in section 501(c)(3), and none of its earnings may inure to any private shareholder or individual. In addition, it may not be an action organization, i.e., it may not attempt to influence legislation as a substantial part of its activities and it may not participate in any campaign activity for or against political candidates. Organizations described in section 501(c)(3) are commonly referred to as charitable organizations. Organizations described in section 501(c)(3), other than testing for public safety organizations, are eligible to receive tax-deductible contributions in accordance with Code section 170. The organization must not be organized or operated for the benefit of private interests, and no part of a section 501(c)(3) organization's net earnings may inure to the benefit of any private shareholder or individual.

According to the teachings disclosed herein, when a donor makes a donation, the intermediary administers the transaction and can direct the donation to multiple 501(c)(3) charities and not-for-profit organizations if the donor so chooses. In addition, the intermediary can offer a wide variety of annuity products, thus providing greater flexibility in how money will be paid out and to whom it will be paid. In terms of security, instead of receiving a stream of payments from a charity, the teachings disclosed herein provide payments backed by highly rated, state-regulated insurance carriers.

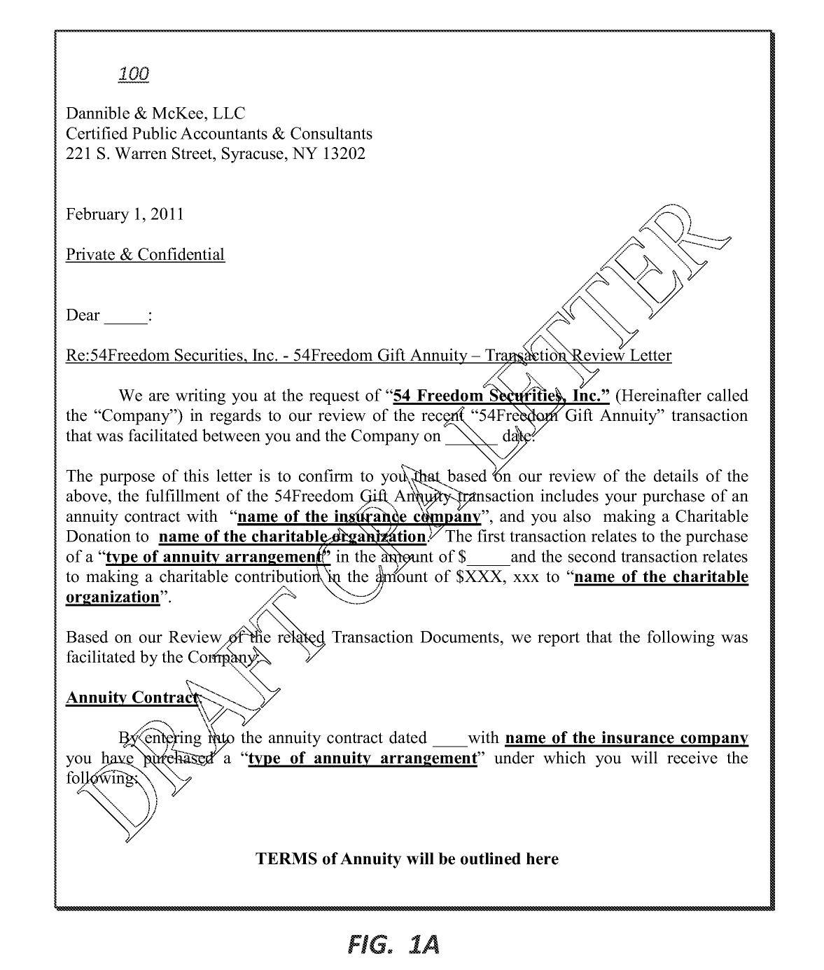

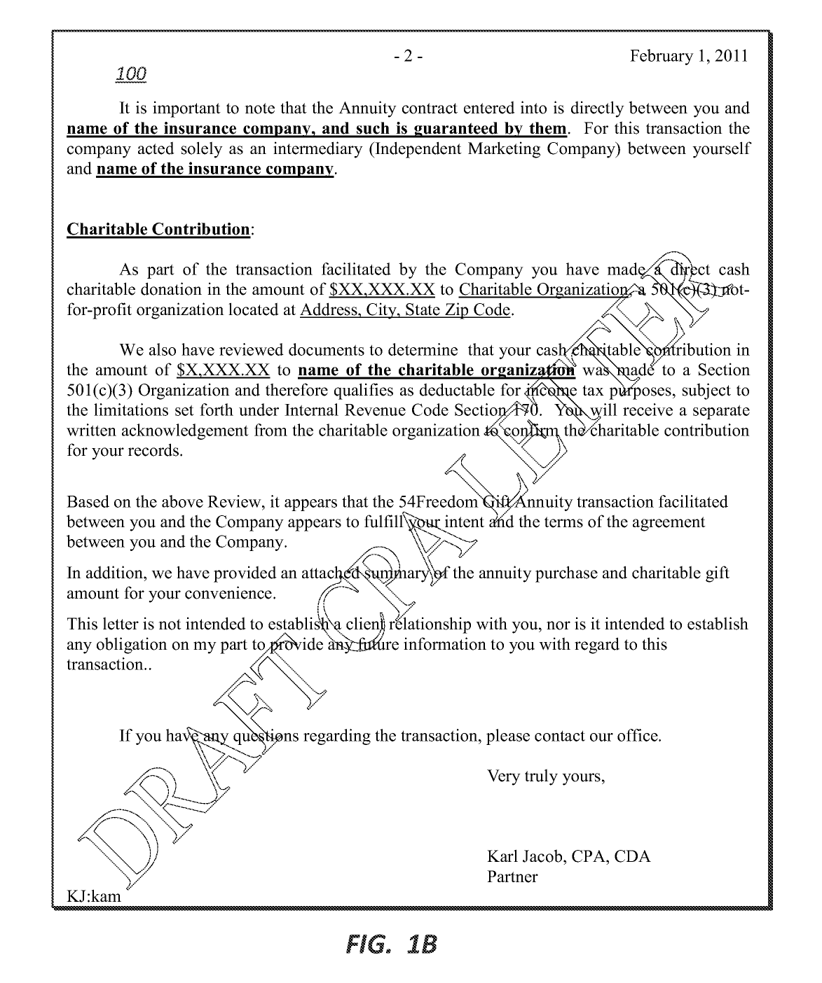

Donors can also find great convenience in a package of services provided by the intermediary which are specifically arranged for the donor thereby. The services can include a certified accountant's review of the donation deduction, and a verification receipt, a letter confirming that donation has been received and annuity is in place from a national certified public accounting firm. An annual annuity tracking and support service provides updates to the donor as to annuity values and other pertinent information as the program matures annually. A draft fillable certified accountant review letter is shown in FIGS. 1A and 1B.

Such a 54Freedom Gift Annuity arrangement works well for people with loved ones who have disabilities and special needs trusts. It also works well for high net worth individuals seeking tax avoidance or tax advantaged investments. Additionally, people with appreciated assets may be interested. Some examples of appreciated assets include CDs, stocks, bonds or other fixed income investments where the interest rate has declined. People who want to lock in growth of appreciated assets but who don't want to pay tax on the capital gain are likely to be interested. People with IRA's which have appreciated greatly may be interested too. Also, a 54Freedom Gift Annuity transaction can help people donate a large sum of money to benefit charities of all kinds

Capital gains on the donated asset are reduced because a portion of the gain is offset by the deduction for a charitable donation. Any remaining capital gains are amortized over life of income stream. Additionally, the asset is removed from estate reducing the taxable estate to the donor's heirs.

Traditional charitable gift annuities include fixed annuities as described by Section 501(m)(5) of the Internal Revenue Code. Four key variables are used to calculate the amount of the annuity payment received by the donor or their loved ones: the amount of the contribution, the number of annuitants, their age, of course, and the annuity interest rate. The ACGA has published suggested charitable gift annuity rates since the 1920's. Although a charity is free to offer any schedule of rates it wishes, so long as its rates don't exceed the limits imposed by federal and state laws, most charities do in fact follow the rates suggested by the ACGA. The payout options can be either immediate or deferred. In addition, the donor can select the frequency with which to receive payments, be it, monthly, quarterly, semiannually, or annually.

There is an immediate allowable tax deduction for current year with a 5 year carry forward, if needed. The maximum actual deduction amount is the amount of the contribution to the charity, minus the present value of the payments that will be made to the beneficiary. The calculation can be made using IRS tables regarding life expectancy and assumed earnings as well as the annuity rate. If the gift annuity is funded with appreciated assets, such as a mutual fund or deferred annuity, and the original donor is the one receiving charitable gift annuity payments, part of the payment will be treated as ordinary income, part will be treated as capital gain, and part tax-free return of capital. With the 54Freedom Gift Annuity, the donor has the flexibility to give a lesser amount of donation and obtain a greater annuity benefit to meet their financial needs.

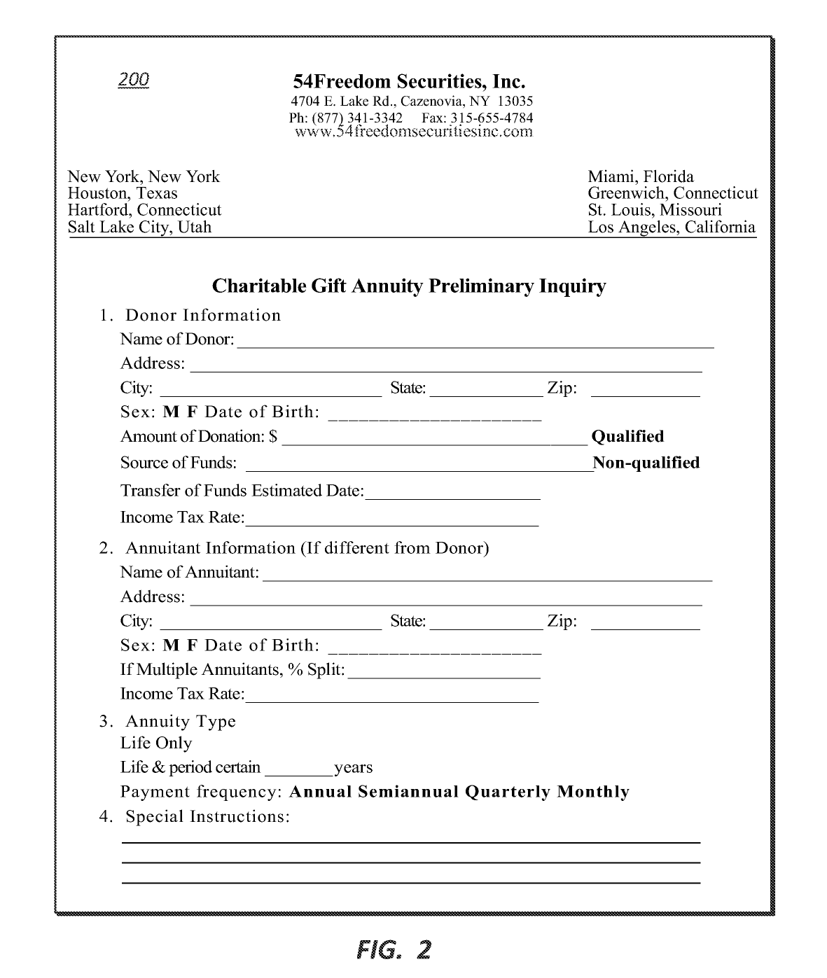

To begin, a potential donor can receive and complete a 54Freedom Gift Annuity preliminary inquiry questionnaire 200, an example of which is shown in FIG. 2, which provides the intermediary with basic information about the donor, annuitant and annuity type desired as shown therein. For example, as shown, the questionnaire can obtain the donor's name, address, sex, amount of donation, source of funds, the estimated date for the transfer of funds, and the donor's income tax rate. The donor questionnaire can further request the name, address, sex, and tax rate of the annuitant. In the instance where there are multiple annuitants, the questionnaire can also identify the percentage split between such annuitants. The donor questionnaire can further identify whether the annuity type is a life only or a life and period for a defined number of years. The donor questionnaire can also define the desired payment frequency of the annuity, such as annual, semiannual, quarterly, or monthly, as well as obtain any additional special instructions from the potential donor.

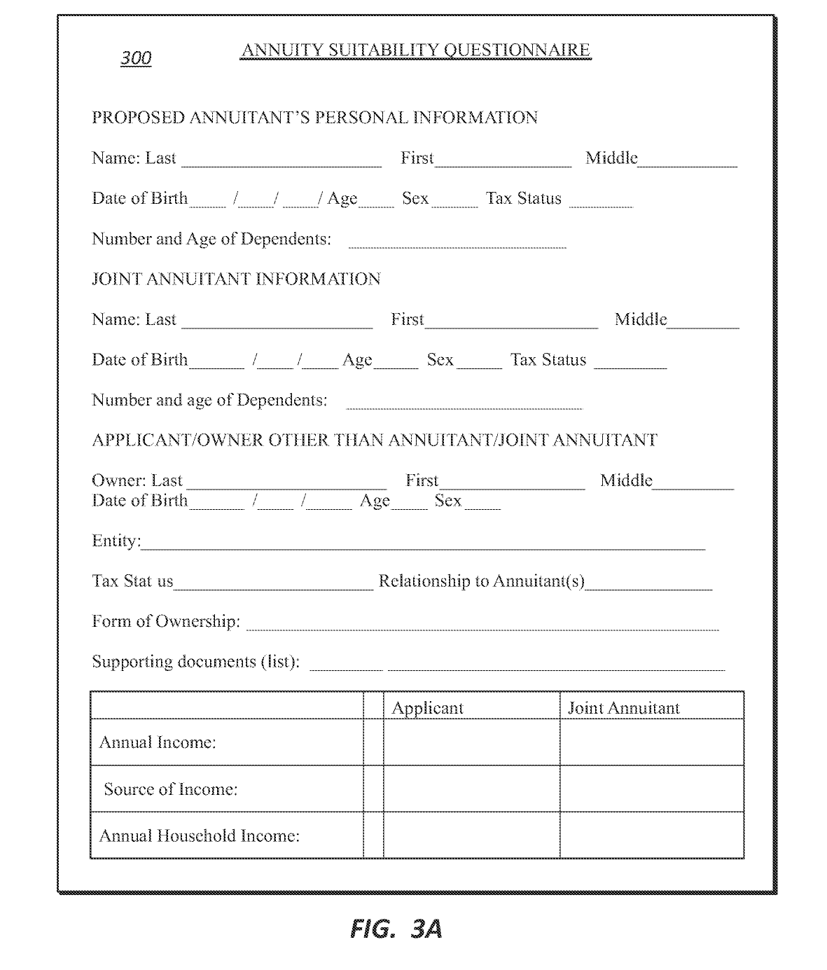

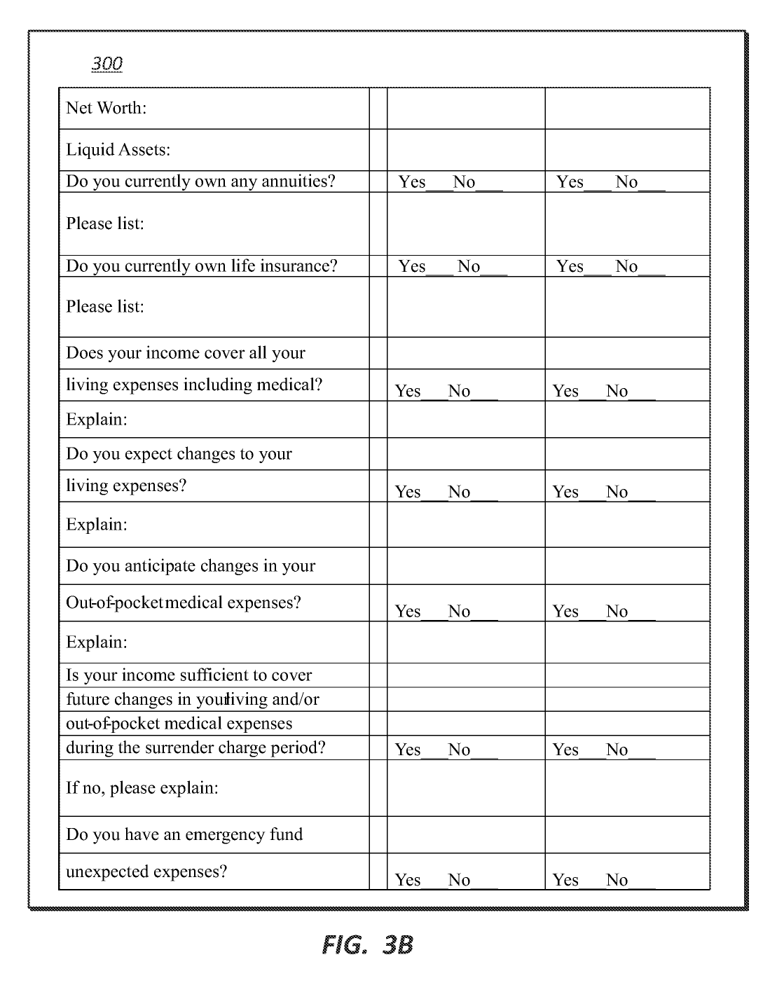

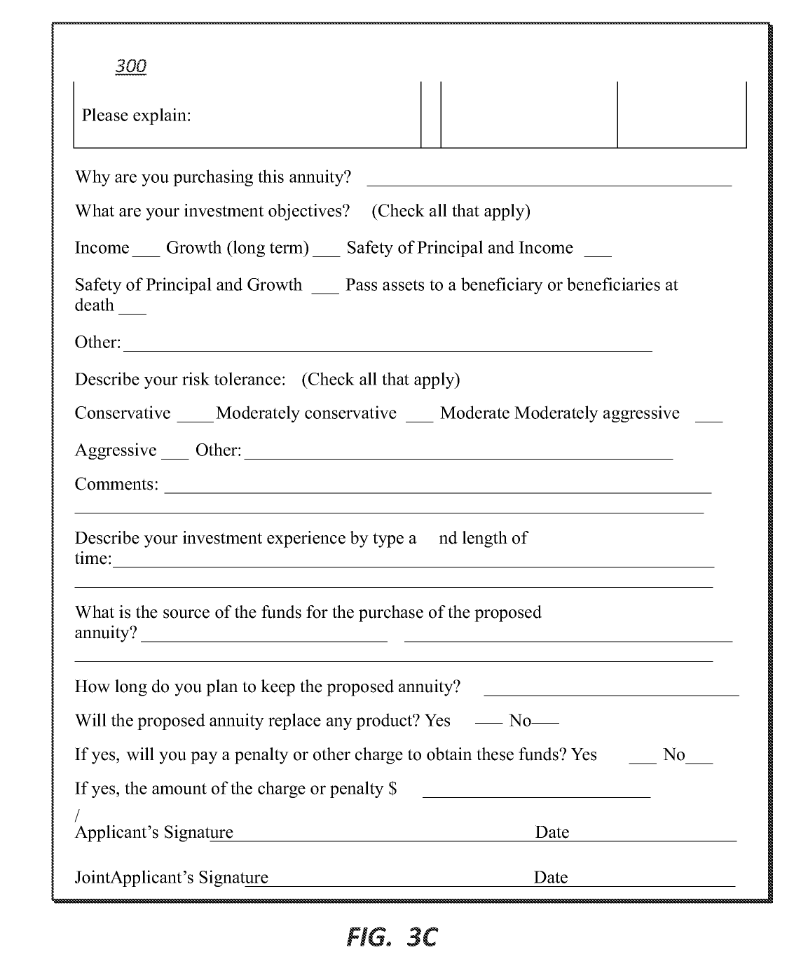

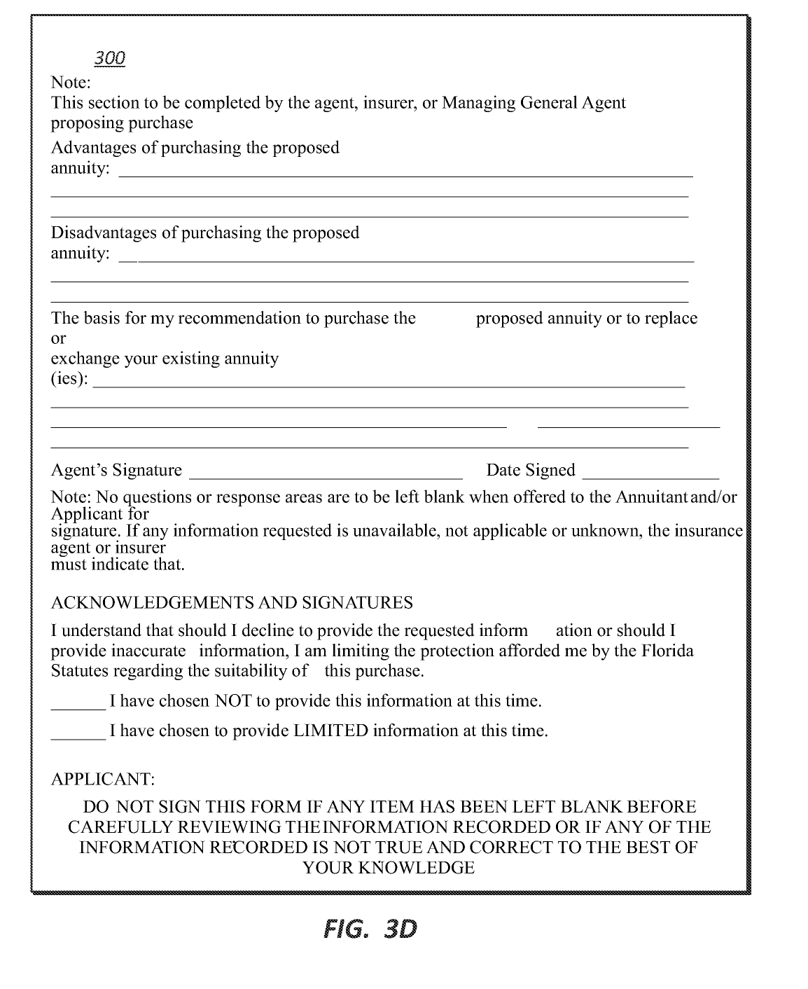

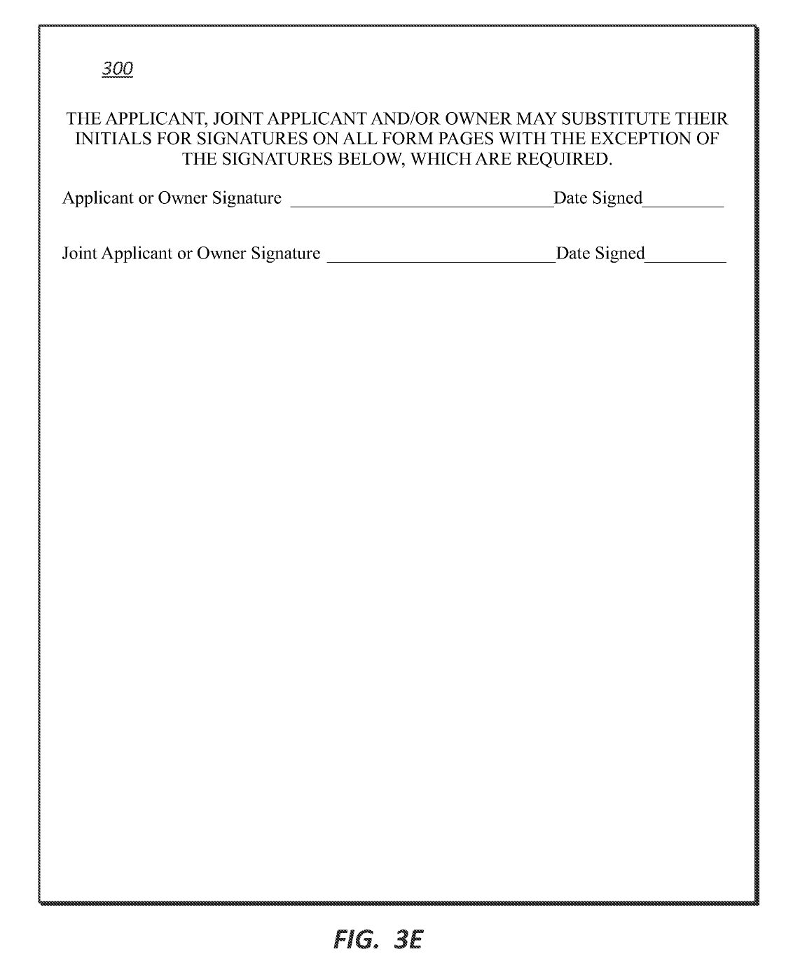

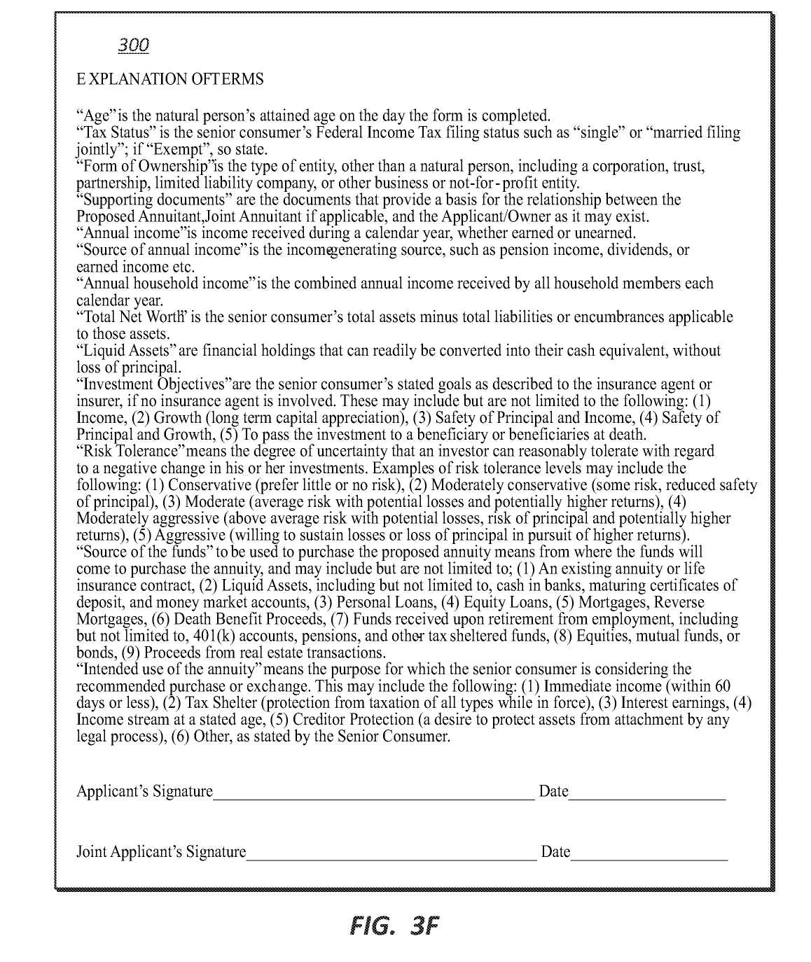

However, according to the teachings disclosed herein the intermediary also obtains information from the potential donor to assess the suitability of the annuity for the donor so as to assess the suitability of the annuity for the donor's financial and life-planning goals. For example, FIGS. 3A-3F illustrate an example of an annuity suitability questionnaire. As shown, in addition to the information above, the suitability questionnaire can obtain the number and age of dependents of the proposed annuitant and similar information about any potential joint annuitant. The suitability questionnaire can solicit information regarding an applicant/owner other than the annuitant/joint annuitant including their name, date of birth, age, sex, entity, tax status, relationship to the annuitant(s), form of ownership, and any supporting documentation for review.

For the potential annuitant(s) the suitability questionnaire can obtain a snapshot of their financial status, needs and tax consequences. For example, the suitability questionnaire can solicit their annual income, source of income, annual household income, net worth, identify liquid assets, whether they currently own any annuities, and if so an identification thereof, whether they currently own life insurance, and if so an identification thereof, whether their income covers all of their living expenses including medical expenses, whether there is any expectation of changes to their living expenses or out-of-pocket medical expenses. The suitability questionnaire 300 can inquire as to future changes in living and/or out of pocket medical expenses during the surrender charge period and whether the annuitant(s) have an emergency fund for unexpected expenses.

The suitability questionnaire 300 can solicit the annuitant(s) financial and life-planning desires. For example, the suitability questionnaire 300 can solicit the reasons for purchasing the annuity, investment strategy (e.g. growth, safety or principal and income, safety of principal and growth, and/or to pass assets to a beneficiary or beneficiaries at death). The suitability questionnaire 300 can solicit the annuitant(s) risk tolerance and inquire as to their investment experience by type of investment and length of time of experience. The suitability questionnaire 300 can solicit the source of the funds for the purchase of the proposed annuity and inquire as to how long the annuity is planned to be kept as well as whether there is any intent to replace the proposed annuity with another product, and if so as to any penalties associated thereto.

As shown in FIG. 3F Examples of fund sources can include (1) an existing annuity or life insurance contract, (2) liquid assets, including but not limited to cash in banks, maturing certificates of deposit, and money market accounts, (3) personal loans, (4) equity loans, (5) mortgages, reverse mortgages, (6) death benefit proceeds, (7) funds received upon retirement from employment, including but not limited to 401(k) accounts, pensions, and other tax-sheltered funds, (8) equities, mutual funds, or bonds, (9) proceeds from real estate transactions.

As shown in FIG. 3F, examples of intended uses of the annuity can include (1) immediate income (within 60 days or less), (2) tax shelter (protection from taxation of all types while in force), (3) interest earnings, (4) income stream at a stated age, (5) creditor protection (a desire to protect assets from attachment by any legal process), (6) other, as stated.

Based on the information obtained by the suitability questionnaire 300, the intermediary accesses the suitability of the applicant for a 54Freedom gift annuity according to the teachings herein and makes recommendations for the potential purchase of a proposed annuity or an exchange of an existing annuity for the donor. The intermediary can assess the advantages and disadvantages of purchasing the proposed annuity for the particular applicant donor based on the information obtained by the suitability questionnaire 300.

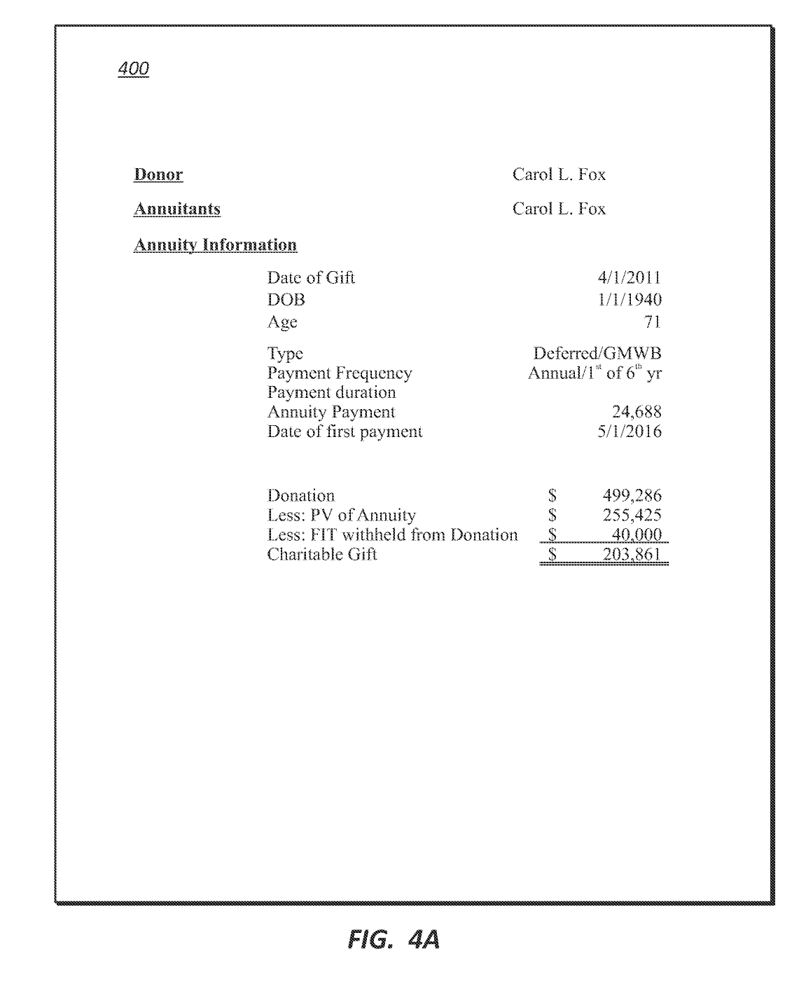

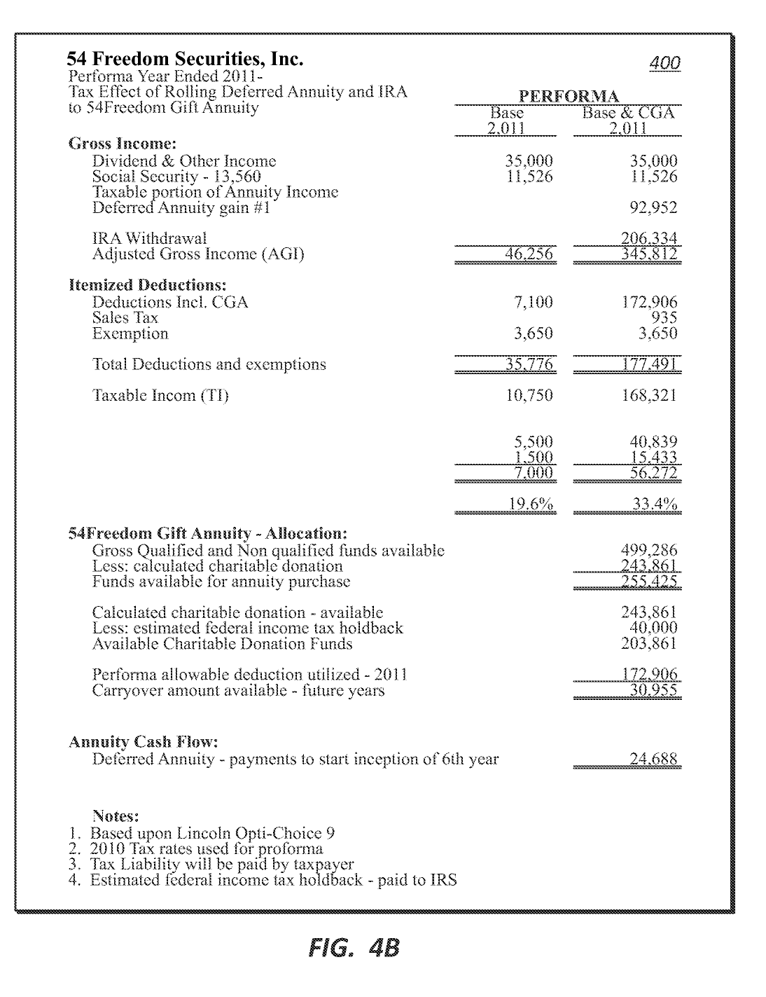

The intermediary can provide the potential donor with a 54Freedom Gift Annuity proposal 400, examples of which are shown in FIGS. 4A and 4B. This proposal can outline the proposed 54Freedom Gift Annuity product for review by the donor including information about the annuity and the charitable gift. The information about the annuity can include the type of annuity, payment frequency, payment duration, annuity payment, and date of first payment. The charitable gift information can include the donation, amounts deducted from the annuity and the total charitable gift as shown in FIG. 4A. The proposal can further provide the donor a proposed itemization of tax consequences for initiating the inventive 54Freedom Gift Annuity as disclosed in the detailed description and summary of this patent application as shown in FIG. 4B.

In addition to the benefits provided to the donor and insurance company, the 54Freedom Gift Annuity methods according to the invention also give intermediaries, such as insurance professionals and marketing companies the opportunity to participate in charitable gift annuity transactions not previously available as the traditional transaction was directly between the donor and charitable institution. And, as such, traditional charitable gift annuities were principally used by high net worth individuals and only offered by larger not-for-profits (e.g. Red Cross, Harvard University). And, the key tax benefits to donors include current tax deduction for donation, offsetting of capital gain on donor's appreciated assets, lifetime payments over one or two lives, much of which is return of principal, and removal of donated assets from donor's taxable estate.

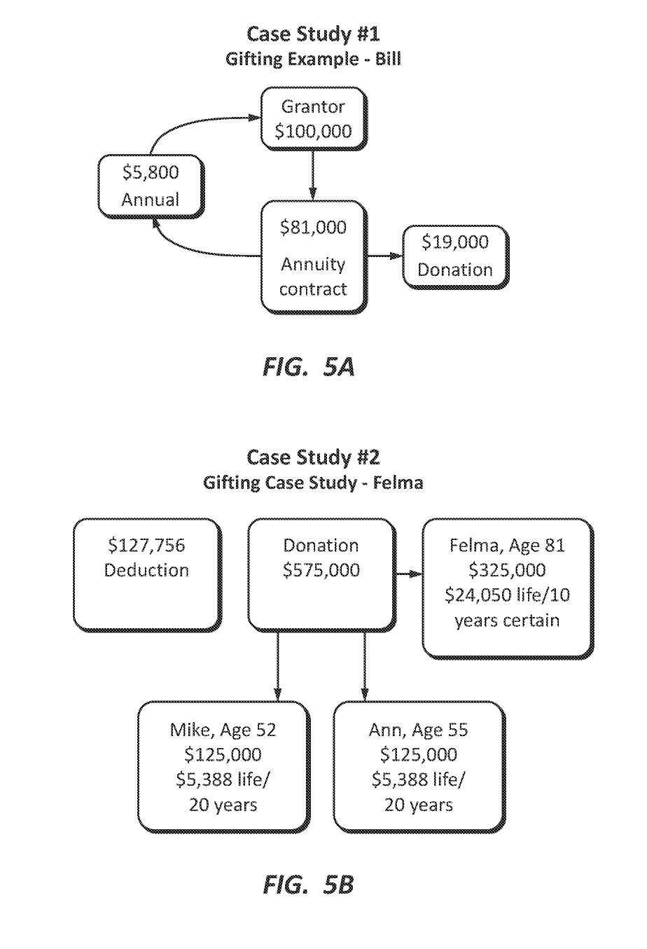

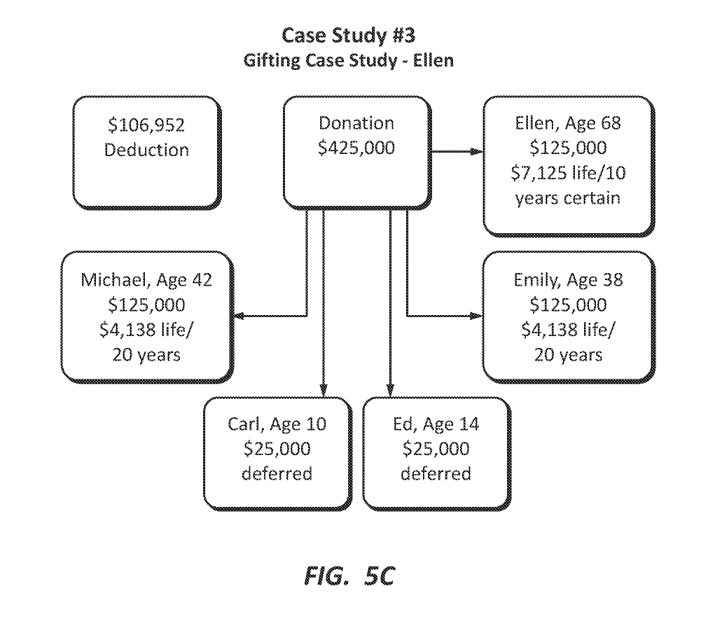

Referring to FIG. 5A a first hypothetical example of a method performed by an intermediary for coordinating the administration of a 54Freedom Gift Annuity arrangement for providing retirement income for a donor or the donor and a loved one is illustrated. In this example, the donor's hypothetical name is Bill. Bill is 70 years old when he decided to consult the intermediary, such as a financial specialist of a marketing company. Bill was a retired manager from the U.S. Postal Service. He owned an underperforming CD and needed income. Bill also had a son, Ryan, aged 48, who had his own security business. Bill could purchase a $100,000 54Freedom gift annuity and receive $5,800 annually for life with a guarantee of at least 15 years, or instead, buy a joint annuity with Ryan as a second beneficiary. Under that arrangement, Bill could receive approximately $4,000 annually for life and, upon Bill's death; Ryan would receive the same amount for his life. Under both scenarios Bill was assured of being able to make a donation.

Referring to FIG. 5B, a hypothetical example of a method performed by an intermediary for coordinating the administration of a 54Freedom Gift Annuity arrangement that provides retirement income for the donor and two loved ones for a donor is illustrated. In this example, the donor's hypothetical name is Felma. Felma is 81 years old, comfortably retired from a career in nursing and has $575,000 in a stock portfolio. She wished to create an income for life for herself as well as help her son Mike, age 52, and daughter, Ann, age 55, both of whom were approaching their retirement years. Additionally, she wished to support the local chapter of ASPCA, where she volunteers weekly.

Felma purchased a $575,000 54Freedom Gift Annuity. $325,000 was assigned to her and $125,000 to each of her children. She received $24,050 per year for the rest of her life with a guarantee of payments for 10 years. Her son will receive $5,388 annually for life with a guarantee of at least 20 years. Her daughter, would receive $5387 annually for the rest of her life with a guarantee of at least 20 years. She also took a $127,756 deduction for donations. Based on Felma's tax rate, she will realize $42,159 in tax savings.

Referring to FIG. 5C, a hypothetical example of a method performed by an intermediary for coordinating the administration of a 54Freedom Gift Annuity arrangement that minimizes estate taxes and provides income for donor and donor family is illustrated. In this example, the hypothetical donor is named Ellen. Ellen is 68 and had inherited an IRA for $425,000. Ellen wanted to create an income for life for herself and provide income for her son Michael, aged 42, and daughter, Emily, aged 38. Additionally, the intermediary helped her to create a deferred income stream for Michael's son, Carl, and Emily's son Ed, aged 10 and 14, respectively.

Ellen purchased a $425,000 54Freedom gift annuity. $125,000 was assigned to her and $125 each to her son and daughter. Additionally, $25,000 was set aside for each of Michael and Emily's children. Ellen received $7,125 per year for the rest of her life with a guarantee of at least 10 years. Michael will receive $4,413 annually for life with a guarantee of at least 20 years. Emily will receive 4,138 annually for life with a guarantee of at least 20 years. Additionally, Ellen avoided paying $35,294 in Federal income taxes.

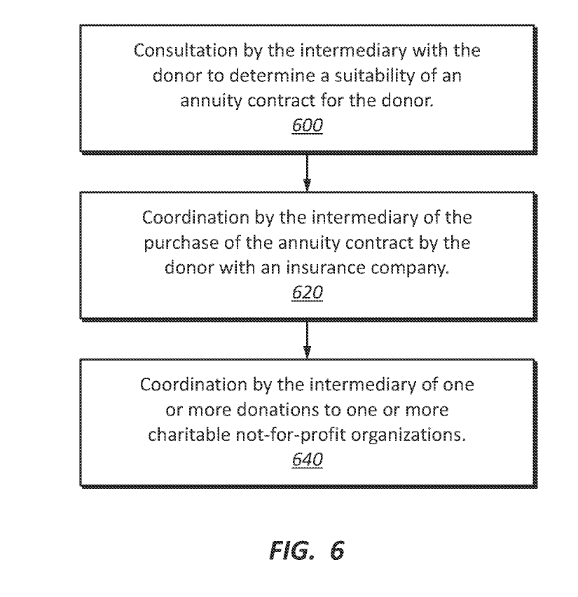

Referring to FIG. 6, a method performed by an intermediary for coordinating the administration of a 54Freedom gift annuity arrangement for a donor is illustrated. The method can include consultation by the intermediary with the donor to determine a suitability of an annuity contract for the donor (600). The consultation can be in-person, over the phone, via mail by filling out a form, by in interactive processing using a graphical user interface associated with a website, or by a combination thereof.

The intermediary can be a financial professional who works for a financial marketing company. The intermediary is preferably not employed by the charitable not-for-profit organization and is preferably also not employed by the insurance company issuing the annuity. As referred to herein, the insurance company need not necessarily issue insurance, but the insurance company is a company distinct from the charity. Such instead of the donor interacting solely with a charity, the donor interacts with the intermediary who interacts with a company issuing the annuity that is separate from the charity. Therefore, it is the insurance company, not the charity that guarantees the annuity contract. And, smaller charities can receive donations and be involved with charitable gift annuities that would not otherwise be able to guarantee such contracts.

Moreover, according to the teachings disclosed herein, the intermediary does not have the financial interests of the charity or the financial interests of the insurance company solely of interest as the intermediary does not work for either institution. Rather, the intermediary can be an employee, or owner, of an independent marketing company that markets the annuity to the donor and insurance company and receives compensation in the form of insurance commissions or financial planning fees when the needs of the donor are satisfied and the transaction complete. Therefore, an important distinction between such embodiments, is that the intermediary can provide better financial advice to the donor, construct a financial arrangement that fits with the donor's particular circumstances, age and familial situation, and concentrate on satisfying the needs and intentions of the donor alone.

One innovation of this approach is that it creates a way for the independent agent or financial planner, e.g. the “intermediary,” to make money on the transaction by receiving commissions. In so doing, the method can create a new point of collaboration and financial benefit for the two parties not currently party to a traditional charitable gift annuity transaction. These parties are the insurance agent who is generally not involved in the transaction at all, and a small charity, which often does not have the wherewithal to pursue these kinds of gifts. Thus, commissions and small charity major gifts do not exist in a traditional charitable gift annuity transaction but are enabled according to the innovative teachings disclosed herein.

The consultation by the intermediary with the donor to determine a suitability of an annuity contract for the donor can include consultation to determine a financial goal of the donor. The consultation by the intermediary with the donor to determine a suitability of an annuity contract for the donor can include identification by the intermediary of the annuity contract based on a comparison of the donor's financial goal and a plurality of annuity contracts from which the intermediary selects the annuity contract. This selection of the annuity contract can also be a custom annuity contract designed by the intermediary and customized for the particular donor.

The method can further include a second charitable donation to a second charitable not-for profit organization. The single (or multiple) annuity contract guaranteed by the insurance company is associated with both the first and second charitable donations. Therefore, the charitable donation that previously was required to be associated with a single annuity, due to the fact that the charitable organization issued the annuity, can now be associated with more than one charitable organization due to the fact that the annuity is issued by an insurance company not associated with the one, two, three, four, or more charities.

During the consultation with the donor, the intermediary can solicit financial information from the donor. The financial information can include a description of the donor's income and assets. The financial information can also include a description of financial information about an annuitant other than the donor. The financial information can also include a description of financial information about the members of a joint annuitant.

During the consultation with the donor, the intermediary can solicit an investment objective from the donor. The investment objective can include income, growth, safety of principal and income, safety of principal and growth, and/or pass assets to a beneficiary or beneficiaries at death. The intermediary can also solicit a risk tolerance from the donor, which can include conservative, moderately conservative, moderately aggressive, and aggressive. During the consultation, the intermediary can also request an identification of the source for funds for the purchase of the annuity.

After the consultation with the donor, but prior to coordination of the purchase of the annuity contract and prior to coordination of the first charitable donation, the intermediary can determine advantages and disadvantages of purchasing the annuity for the donor.

During the consultation with the donor, the intermediary requests the donor's tax rate percentage. After the consultation with the donor, but prior to coordination of the purchase of the annuity contract and prior to coordination of the first charitable donation, the intermediary can provide the donor with an illustrated projection of the annuity to be paid by the donor and the charitable donation to be paid by the donor along with tax consequences for the donor associated with such payments.

Next, the intermediary coordinates the purchase of the annuity contract by the donor with an insurance company (620). The insurance can be a large financially insured and regulated insurance company. The intermediary can provide the donor with the insurance company's annuity application, and once completed, communicate the completed annuity application to the insurance company. The intermediary can also review the donor's completed annuity application so as to ensure that the application is correctly, and optimally, completed according to the consultation between the intermediary and the donor. The intermediary can also be available to review the annuity application with the donor and answer any questions that the donor might have.

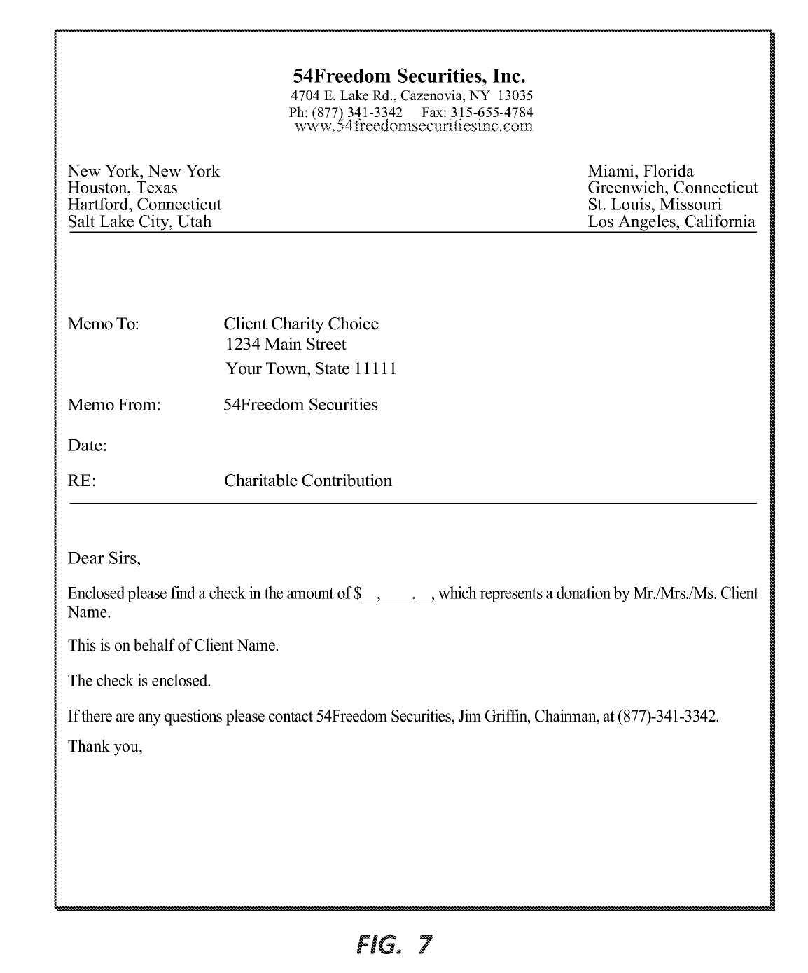

The intermediary next coordinates one or more charitable donations to one or more charitable not-for-profit organizations (640). FIG. 7 is an example of a letter sent by the intermediary to the charity enclosing a check for the charitable donation to coordinate payment of the charitable donation. Here, the annuity contract is guaranteed by the insurance company, the intermediary is not employed by the charitable not-for-profit organization, and the insurance company is not a charitable not-for-profit organization.

Such steps and acts can be carried out using a telephone, email, on a computer interactive website, or a combination of such, and other, tangible machines. Such steps and acts also transform money from one instrument form to another. For example, money held in cash, or a CD, IRA, or other investment product can be transformed into one or more annuity products as discussed herein.

The steps and acts disclosed herein can be performed in software taking the form of a computer program product with computer readable instructions which, when executed by the computer, cause the computer to perform one or more of the steps and acts disclosed herein. For example, the consultation by the intermediary with the donor can include a form or interactive graphical user interface provided by hardware, such as a computer processor or other logic device, executing software, which presents the questionnaire to the donor. The consultation can be solicited by advertising or can be unsolicited where the donor visits a website to initiate the consultation.

The selection of the annuity contract based on the consultation by the intermediary (e.g. software, an employee, a website, a form, or a combination thereof) with the donor can be performed by software and/or a financial specialist. Similarly, coordination by the intermediary of a purchase of the annuity contract by the donor with the insurance company can be performed in software where form fillable applications can be automatically submitted to the insurance company once selected and approved by the donor.

Coordination by the intermediary of the first charitable donation with the first charitable not-for-profit organization can also be performed by software and/or a financial specialist. In one instance a letter is sent to the one or more charities along with a check, wire, or other financial instrument to transfer the donation to the one or more charities.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method performed by an intermediary for coordinating the administration of a gift annuity arrangement for a donor, comprising:
consultation by the intermediary with the donor to determine a suitability of an annuity contract for the donor;
coordination by the intermediary of a purchase of the annuity contract by the donor with an insurance company; and
coordination by the intermediary of a first charitable donation to a first charitable not-for-profit organization, wherein the annuity contract is guaranteed by the insurance company.

2. A method according to claim 1, wherein the intermediary is not employed by the charitable not-for-profit organization and is also not employed by the insurance company.

3. A method according to claim 1, wherein the annuity contract is not guaranteed by the first charitable not-for-profit organization.

4. A method according to claim 1, wherein the intermediary includes an employee of an independent marketing company that markets the annuity to the donor, markets the donation to charities, and also markets the annuity to the insurance company.

5. A method according to claim 1, further comprising:
consultation by the intermediary with the donor to determine a financial goal of the donor; and
identification by the intermediary of the annuity contract based on a comparison of the donor's financial goal and the annuity contract.

6. A method according to claim 1, further comprising a second charitable donation to a second charitable not-for-profit organization, wherein the annuity contract guaranteed by the insurance company is associated with both the first and second charitable donations.

7. A method according to claim 1, wherein during the consultation with the donor, the intermediary solicits financial information from the donor.

8. A method according to claim 7, wherein the financial information includes the donor's income and assets

9. A method according to claim 7, wherein the financial information includes financial information about an annuitant other than the donor.

10. A method according to claim 7, wherein the financial information includes financial information about the members of a joint annuitant.

11. A method according to claim 1, wherein during the consultation with the donor, the intermediary solicits an investment objective from the donor.

12. A method according to claim 11, wherein the investment objective includes income, growth, safety of principal and income, safety of principal and growth, and/or pass assets to a beneficiary or beneficiaries at death.

13. A method according to claim 1, wherein during the consultation with the donor, the intermediary solicits a risk tolerance from the donor.

14. A method according to claim 13, wherein the risk tolerance includes conservative, moderately conservative, moderately aggressive, and aggressive.

15. A method according to claim 1, wherein during the consultation with the donor, the intermediary requests identification of a source of funds for the purchase of the annuity.

16. A method according to claim 1, wherein after the consultation with the donor, but prior to coordination of the purchase of the annuity contract and prior to coordination of the first charitable donation, the intermediary determines advantages and disadvantages of purchasing the annuity for the donor.

17. A method according to claim 1, wherein during the consultation with the donor, the intermediary requests the donor's tax rate percentage.

18. A method according to claim 17, wherein after the consultation with the donor, but prior to coordination of the purchase of the annuity contract and prior to coordination of the first charitable donation, the intermediary provides the donor with an illustrated projection of the annuity to be paid by the donor and the charitable donation to be paid by the donor along with tax consequences for the donor of such payments.

19. A method according to claim 1, wherein after the consultation with the donor, but prior to coordination of the purchase of the annuity contract and prior to coordination of the first charitable donation, the intermediary provides the donor with an illustrated projection of the annuity to be paid by the donor and the charitable donation to be paid by the donor.

20. A method according to claim 1, further comprising the intermediary receiving compensation in the form of commissions.

21. A method according to claim 1, further comprising the intermediary receiving financial planning fees.

22. A method performed by an intermediary for coordinating the administration of a charitable gift annuity arrangement for a donor, comprising:
application for an annuity by the intermediary on the behalf of a donor with an insurance company; and
coordination by the intermediary of a first charitable donation to a first charitable not-for-profit organization, the first charitable donation being associated with the annuity, wherein:
the annuity contract is guaranteed by the insurance company; and
part of the payments of the annuity are taxed as ordinary income and part of the payments of the annuity are tax-free due to the charitable donation.

23. A method performed by an intermediary for coordinating the administration of a charitable gift annuity arrangement for a donor, comprising:
consultation by the intermediary with a donor to determine a suitability of an annuity contract for the donor, including:
solicitation of financial information from the donor including the donor's annual income, investment objectives, risk tolerance, and tax rate;
consultation by the intermediary with the donor to determine a financial goal of the donor;
consultation by the intermediary with the donor to determine a risk tolerance of the donor; and
solicitation of the donor's age;
selection of the annuity contract based on the consultation by the intermediary with the donor including the suitability of the annuity contract with the donor's annual income, investment objectives, risk tolerance, tax rate, financial goal, and donor's age;
coordination by the intermediary of a purchase of the annuity contract by the donor with an insurance company; and
coordination by the intermediary of a first charitable donation to a first charitable not-for-profit organization, wherein the annuity contract is guaranteed by the insurance company instead of the charitable not-for-profit organization where neither the insurance company nor the charity employ the intermediary.
